(19) United States
(12) Patent Application Publication
(10) Pub. No.: US 2003/0007182 A1
(43) Pub. Date: Jan. 9, 2003

(54) Customer specific image data processing

(76) Inventors: Dieter Franzke, Windisch (CH); Markus Naf, Zurich (CH)

Correspondence Address: Frederick G. Michaud, Jr., BURNS, DOANE, SWECKER & MATHIS, L.L.P., P.O. Box 1404, Alexandria, VA, 22313-1404, US

(21) Appl. No.: 10/188,854

(22) Filed: Jul. 5, 2002

(30) Foreign Application Priority Data
Jul. 5, 2001 (EP) 01 115 701.3

(51) Int. Cl. G06F 15/00; G06K 1/00

(52) U.S. Cl. 358/1.18

(57) ABSTRACT

The invention relates to an image data processing device for photographic image data with an input for the input of digital, photographic image data and, in accordance with the invention, individualization-identification data, which are assigned to the image data, whereby an assignment device assigns manipulation parameters on the basis of the individualization-identification data associated with the image data, which parameters are used to modify the image data to be optimized in an image data modifying device, in order to output the target image data produced thereby through an output, for example in the form of a photographic printer.

### FIELD OF THE INVENTION

The present invention relates to an image data processing device for use especially in a photo printer or photolab. Furthermore, the invention relates to a photographic printer and a process for the adaptation of image data.

### BACKGROUND ART

Photographic image data are conventionally provided to an image data processing device by scanning a film, or directly from digital data carriers, or by way of the internet or networks. The image data processing device normally carries out correction processes in order to optimize the image data (for example Eye-Tech-Processing, see for example EP 96810235.0, EP 96810499.2, EP 96810554.4, EP 99101595.9, EP00100242.7, EP00104491.6). This correction processing and the optimization processes often have the purpose to process the image data in such a way that the photographic image printed in the end is as “realistic” as possible. “Realistic” in this respect means that the image impression observed by the photographer during the taking of the picture is reproduced as exactly as possible. Conventional processes are herefor based especially on an image analysis. Some processes can, for example, also consider the film type, if it is known, during the image analysis in order to correct, for example, film typical color shifts. It is a disadvantage of the above mentioned processes that they cannot take into consideration either the individual taste of one customer nor individual tastes of customers which can be grouped together.

### SUMMARY OF THE INVENTION

It is an object of the invention to provide an image processing device and a process for image data processing which enables an individualized processing of the image data for individual customers or for groups of customers, in order to fulfill as best as possible the customer specific requirements on the subjective appearance of pictures.

The image data processing device in accordance with the invention receives the photographic image data to be processed, for example, from the scanner. In addition to the photographic image data it receives individualization-identification data. Those refer, for example, to a customer number or a certain taste profile (for example preference for rich colors, skin tones somewhat darker than real, etc.) or customer data or a customer profile (for example sex or age of the customer or nationality or country or residence) and a taste profile typically asssociated therewith. The image data processing devices in accordance with the invention can, for example, be provided with country specific individualization identification data which lead to the respective “country taste” being optimally achieved. Depending on the place of delivery, the country specific or region specific individualization-identification data can be preset. However, they can also be made selectable. It is also preferably possible to access a customer data memory by way of a customer's number and to then recall a taste profile data base on the basis of the stored customer's data, for example, sex, age, nationality, regionality (for example in Europe, Asia, America, etc.) and to recall the taste profile for the respective customer data and the individualization-identification data which are associated with or correspond to the taste profile. Thus, on the basis of customer data, individualization-identification data are preferably determined which are associated with the customer data, for example, in a memory. Preferably, the individualization-identification data are respectively assigned to the received image data.

Image data can be provided in one step, for example, to a conventional image data optimization device which, for example, carries out dynamic range adaptations, brightness corrections, color value corrections and so on. According to one embodiment of the invention, this optimization process occurs depending on manipulation parameters. The manipulation parameters, for example, set the extent of the brightening, the extent of the color correction, and so on. Thus, they interfere in a controlling manner with the optimization process. The manipulation parameters are stored for the respective individualization-identification data. This means that for each individual customer or for each customer group or for certain countries, a specific image data optimization can be carried out by way of the individualization-identification data.

According to the invention, a process is also suggested for the adaptation of image data to individual customer wishes for the achievement of the object or objects underlying the present invention. Data on customer specific optimized image data are thereby determined with respect to at least one image standard or calibration image in order to produce individualization-identification data. A customer or customer group with the same customer profile can thereby observe at least one image standard and modifications thereof, whereby certain deviations from the image standard in color, sharpness, contrast, and so on can be provided in pre-selectable steps. The customer or the customer group can thereby select a certain image, which thus corresponds to his expectations and his color perception or his perception of beauty. On the basis of this selection, individualization-identification data can then be produced, on the basis of which manipulation parameters are then determined and assigned customer specific individualization-identification data. For a customer group, this is carried out, for example, by communication of the selection made by the individual members of the customer group. The individualization-identification data determined, or the determined manipulation parameters can then be stored in order to be used when the customer or the customer group hands over any image data in the form of film negatives, memory contents of digital cameras or the like, for the production of photo prints, in order to change image data intended for reproduction by way of the manipulation parameters. The changed image data can then be output as customer specific optimized target data on the basis of the manipulation.

For use of a corresponding optimization service, a smart card can be handed out to a customer, for example, which includes corresponding individualization-identification data and/or manipulation parameters, which during order placement or handing in of an order for the development of a film, can be read in for the printing of the image content of a memory of a digital camera, and so on, and used for the photofinishing process.

It is thereby of course also sensible to divide images into diverse classes of images, for example, landscape photographs, portrait photographs, night time photographs, flash photographs, winter landscape photographs and so on, and to carry out a corresponding process with a picture standard and its modifications for a certain selection of such image classes or for all such image classes which occur often, in order to be able to, for example, collect well grounded information during the first utilization of the service for the generation of customer specific optimizing picture copies. Although it is possible that customers generally have a wish to find a most radiant sky blue, most delicately tanned human skin, and so on, on the pictures but it is also possible that for certain image classes a weaker or stronger contrast, a higher sharpness, or the like is desired which can be captured and eventually realized much better for different image classes by the capture of individualization-identification data.

It is thereby also possible to classify not only pictures, but to also divide customers into different classes, such as those which prefer a certain sky blue and those which wish to see certain brown skin types. It is then possible to again determine optimized and simplified manipulation parameters for use for a certain customer group. It would then only still be required, for example, to assign a certain set of manipulation parameters to a larger number of customers by way of a 2 or 3 digit number or a corresponding multi-digit code. Only upon complaints of those customers can corresponding customers then be assigned to other classes which have other manipulation parameters. Separate individualization-identification data and/or manipulation parameters can be calculated and stored for non-classifiable customer wishes. The manipulation parameters can thereby also be provided device independent with a standard and during use of the manipulation parameters within a photoprinter of the applicant certain adaptation of the parameters can be carried out while other adaptations can be carried out on photoprinters of other manufacturers, whereby the adaptation parameters can also equally belong to the manipulation parameters set.

On the other hand, it is also possible, when customers are not to be first burdened with a standard image and its modifications, or several standard images and their modifications, to initially assign a customer to a specific class of individualization-identification data or the manipulation parameters assigned to those data, whereby the assignment can be carried out according to probabilities. Thus, it is normally the case that especially so called memory colors which are especially imprinted on humans or are perceived as especially pleasant, appeal especially to a majority of customers. Certain constellations of depth sharpness/contrast and/or the like are also perceived as especially pleasant by a majority of customers. In this manner, a set of manipulation parameters which is especially probable can be initially assigned to a customer. Only later, when the customer complains about certain photographs, a change of the individualization-identification data and/or the corresponding manipulation parameters be carried out, depending on the image class into which the objected to pictures fall, in order to be able to carry out a further adaptation of the images for specific customers.

If a customer with his wishes comes very close to the image data which are achieved after the optimization on the basis of a conventional image data optimization, a threshold interval can be defined within which customer wishes for all or certain image classes are not taken into consideration. This means, when a class of customers or certain customers like images which were only routinely optimized, eventual individualization-identification data can be ignored, since they could only yield the most minimal changes and would thereby cost calculation and processing time, but would not trigger a significantly higher acceptance or satisfaction of the customer.

In order to determine to what extent a customer specific manipulation of image data is required, certain supporting locations can be removed from the image data of a picture, for example, in order to test whether or not a blue after routine optimization already sufficiently corresponds to a specific customer wish or a memory color. If it is determined on the basis of a number of supporting locations from the image data of a picture that the difference between the customer wish and the already present image data is negligible or within an acceptance interval, the additional processing of the image data can be omitted.

Of course, the customer can also transfer the individualization-identification data online, such as by internet or dataline. It is also possible to enter corresponding individualization-identification data or manipulation parameters, for example, in the memory of a digital camera, so that those data are present when the digital image data of the camera are to be used for the manufacture of copies. It is also possible to transmit to the photolab, the corresponding individualization-identification data and/or manipulation parameters, for example, in the form of applicable, especially adhesive, barcode strips, for example, adhered to order pouches with film negatives. Several different methods are herefor known to the person skilled in the art in order to have the corresponding data of a certain customer present for developing.

In an alternative embodiment, the image data can be first or later fed to a conventional optimization device. The then optimized image data are thereafter fed to the image data modification device. The optimized image data are then manipulated in the image data modification device, for example, with a view to their color value (color tone, color saturation, etc.) depending on the customer specific manipulation parameters (for example by way of digital masks). The manipulation parameters which are to be used during this process are again determined by way of the individualization-identification data.

According to one example, the individualization-identification data are therefore stored together with the associated manipulation parameters in a table or data fields. The image data are then changed based on the manipulation parameters which are assigned in the table, for example, to a customer number or a selected taste profile. For example, if this is preferred by the customer, the color saturation of sky blue tones is increased or the color tones of face colors is somewhat shifted to towards red. A softening or sharpening of the image or of image portions (for example softening of a face) can also be carried out customer specific by way of the manipulation parameters. The manipulation can also be carried out image class dependent or customer class dependent, for example, a darkening or color tone change only for beach pictures (for example corresponding to the view through sunglasses).

It can further be provided, for example, for professional photographers, that the image data are not optimized or optimized to only a limited extent in order to thereby avoid that desired artistic effects are alienated.

### BRIEF DESCRIPTION OF THE DRAWINGS

The present invention will be further described in the following by way of preferred embodiments, whereby further objects, advantages and features of the invention will be disclosed. The invention will be described with reference to the drawings, wherein

FIG. 1 is a block diagram of a special image data processing device with features according to the invention, whereby the illustrated box also represent steps of a preferred variant of a process in accordance with the invention;

FIG. 2 is a refined plot diagram of a portion of FIG. 1; and

FIG. 3 is a block diagram of an alternative embodiment of the preferred embodiment according to FIG. 1.

### DETAILED DESCRIPTION OF THE PREFERRED EMBODIMENTS

Components or process steps which are equal or at least of equal function are identified in the figures by the same references. Correspondingly, a repeated discussion of the same components is obviated.

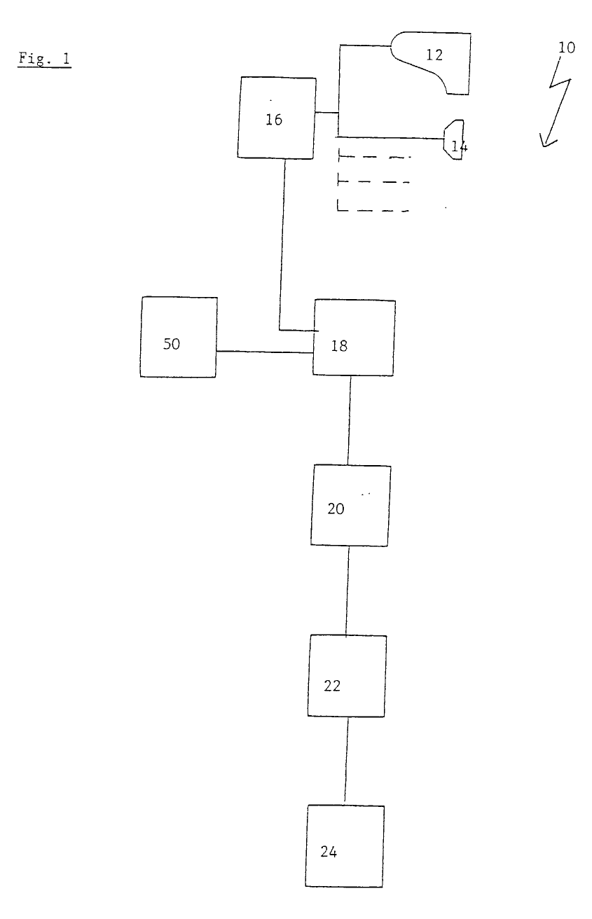

FIG. 1 shows a first embodiment of an image processing device 10 with the features according to the invention.

The device 10 receives various data through a scanner 12, through a data line connection 14, or the like, for example over the internet. The broken lines are intended to illustrate other possible data interfaces included in the device 10. The incoming data can be digital photographic image data and/or individualization-identification data. Of course, these data can also be stored so that the devices through which the input device 16 receives information can also include a memory or read-in stations for memories of digital cameras.

The photographic image data and the individualization-identification data arriving in the input device 16 are mutually associatedly handled and an assignment device 18 assigns the individualization-identification data associated with the image data of a customer order to certain manipulation parameters which are to be used to adjust the image data to the wishes or perception of beauty of a specific customer. It has to be remembered, that the individualization-identification data can of course also be directly represented by the manipulation parameters or represent them directly, depending on the standardization or transferability onto the process for the image data change. This means the individualization-identification data which can be used for the calculation of manipulation parameters can also directly correspond to the manipulation parameters which can then be used without further adaptation for modification of the image data to be optimized.

An image data modification device 22 can use the manipulation parameters in order to modify the optimized image data according to the manipulation parameters for the generation of target data. Finally, an output, for example in the form of a printer, a DMD-illumination unit, an inkjet printer or other components can be used for the output of the target image data by exposing them onto photosensitive paper or reproducing them on paper by way of inkjet application.

FIG. 1 illustrates a possible modification on how, for example, by way of a unit 50 for the determination of individualization-identification data, those data can be determined and used. This means the unit 50 according to the desired or required type provides individualization-identification data which are customer specific or customer group specific, for adapting image data to customer wishes or customer group wishes.

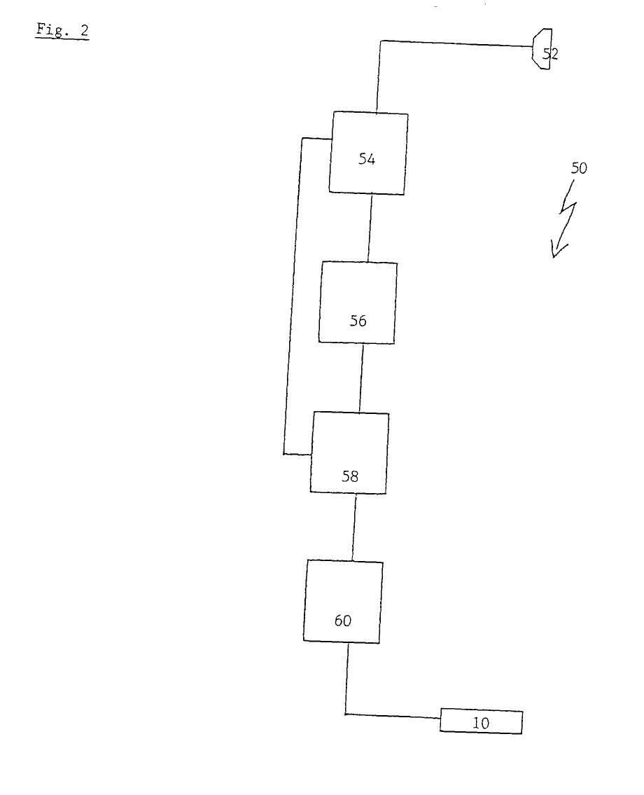

The device 50 can thereby be constructed according to FIG. 2. For example, individualization-identification data can be read in through a data line connection, such as an internet connection 52. Otherwise, a corresponding individualization-identification data set can also be determined directly locally by test data capture, for example the capture of test images or the capture of error complaints, in order to analyze corresponding data, and possibly store them, or to otherwise process these data according to the invention or otherwise. Of course, one must consider during the test data capture that the test data are captured with the consent of the customer in order to comply with data protection regulations. The device for the capture of the test data on the basis of which the individualization-identification data are determined can be connected to a grouping device 56. This grouping device is provided for the assignment of certain customer specific individualization-identification data, for example, to a group of customers, which within a certain range have the same preferences relative to the image data to be reproduced. Should a grouping not be possible, because a corresponding customer has special reproduction wishes, the individualization-identification of the customer can be forwarded unclassified to a possibly connectable threshold device 58. The threshold device 58 can ensure, for example, by way of a threshold interval or concrete threshold values that individualization-identification data are taken into consideration in a certain manner or not at all, if, for example, the individualization-identification data lead to only small changes of the image data or to changes which can already be achieved by conventional image data optimization. Supporting locations within the image data can here also be used in order to determine by way of the supporting locations the effect of a corresponding change of the image data.

Additionally, a statistics device 60 can be provided which captures statistical data for the determination which average customer wishes are present in order to be able to carry out in this manner a general modification of image data. This means that a conventional image data optimization can be influenced in this manner and adapted to a common trend in customer taste, irrespective of whether the customers want to take advantage of the additional service of an image data processing device according to the invention.

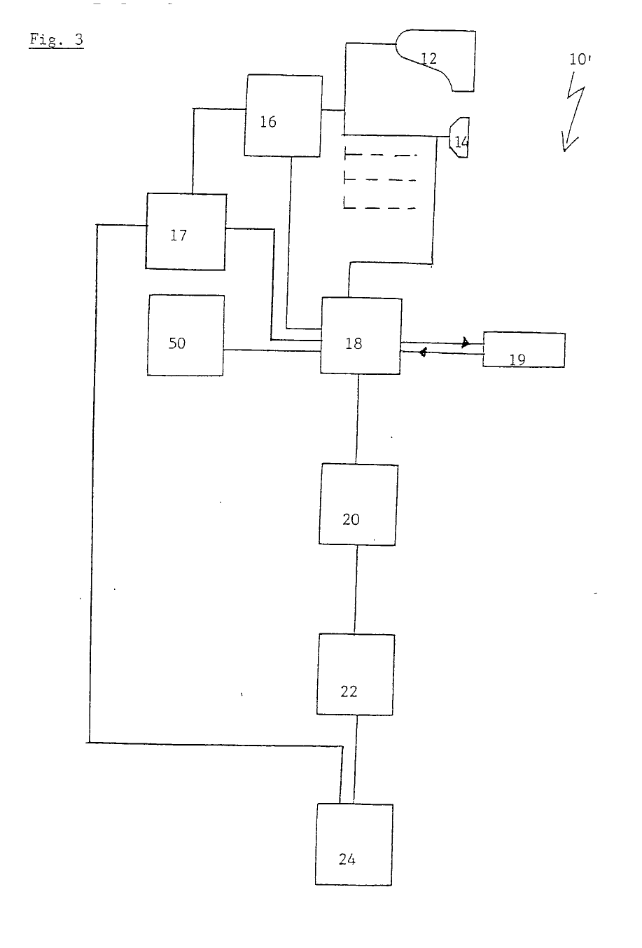

Finally, the individualization-identification data intended for the further processing are transmitted to the device 10 or 10′ according to FIG. 1 or FIG. 3, which will be described in the following.

FIG. 3 illustrates a construction in which the components according to FIG. 1 and FIG. 2 are used. Furthermore, an image data optimization device 17 is here provided which can optimize image data before a customer specific change of the image data in the image data modification device 22 is carried out.

According to FIG. 3, the assignment device 18 can inquire manipulation parameters directly through a data line from a data connection or an internet connection 14 or the like or from the device for determination of individualization-identification data 50.

A conventional image data optimization device 17 can obtain the image data directly from the input device 16 in order to generally pre-optimize them on the basis of any, even conventional image data processing methods. The image data optimization can thereby be influenced also by the device 50, for example by way of the statistic device 60 according to FIG. 2.

It can be captured by way of a threshold device 19 whether image data on the basis of determined manipulation parameters are within certain limits relative to the image already optimized by the device 17, so that a further slightly or not at all visible manipulation of the image data can be obviated. In that case, the threshold device 19 can issue a command to the device 18 so that image data are not subjected to a further customer specific manipulation, but are transmitted, for example, directly by the conventional optimization device 17 to the output device 24.

As already indicated above, the set of individualization-identification data required according to the invention can be assembled in any desired manner. Starting with the possibility that the individualization-identification data of a customer can be arbitrarily assigned to await his correcting complaints, to the possibility that the respective customer generates with great effort his own individualization-identification data, a multitude of different processes are possible for the generation of a corresponding individualization-identification data set. A first or even a closing individualization-identification data set can then be partly or completely automatically generated by way of statistics. This can also be carried out by way of internet, postal service or otherwise.

The individualization-identiflcation data or information parameters determined specifically for one customer can be later manipulated depending on the later customer behavior, which means, for example, depending on complaints or hints and adapted to customer wishes or changing customer wishes.

1. Image data processing device for photographic image data, comprising
an input for the input of digital, photographic image data and customer individualization-identification data assigned to the image data;
an assigning means for assigning manipulation parameters to the image data on the basis of the individualization-identification data;
an image data modifying device for modifying the image data to be optimized according to the manipulation parameters in order to produce target data; and
an output for outputting the target data.

2. Image data processing device according to claim 1, wherein the image data modifying device modifies the image data in such a way that at least one image property is changed in dependence of the manipulation parameters.

3. Image data processing device according to claim 1, wherein the image data modifying device modifies at least one color value represented by the image data.

4. Image data processing device according to claim 1, wherein the image data modification device locally modifies at least one color value in dependence of the manipulation parameters.

5. Image data processing device according to claim 1, wherein the image data modifying device carries out the extent of the modifications in dependence of the manipulation parameters.

6. Image data processing device according to claim 1, wherein the image data modifying device includes an image data optimization device for optimizing the image data based on given standard information and independent of the manipulation parameters; and
an image data manipulator for carrying out one of a manipulation the optimized images according to the parameters, no manipulation in dependence of the manipulation parameters, and a determination and execution of an extent of the manipulation in dependence of the manipulation parameters.

7. Photographic printer or photographic lab, especially a minilab for the production of photographic prints on a medium with the image data processing device of claim 1.

8. Process for the adaptation of image data to individual customer wishes, comprising the steps of
a) determining data on customer specific optimized image data in relation to at least one image standard for generating individualization-identification data;
b) assigning the individualization-identification data to manipulation parameters;
c) modifying image data intended for reproduction by way of the manipulation parameters; and
d) outputting the customer specifically optimized, modified image data as target data.

9. Process according to claim 8, wherein the individualization-identification data of specific customers within preselectable intervals are combined to customer groups and assigned to customer group specific manipulation parameters.

10. Process according to claim 8, wherein the reproduction of certain image data is only then customer specifically changed, when a deviation between the image data and the target image data exceeds a preselected threshold value.

11. Process according to claim 8, wherein the image data of images are divided into different classes and customer specifically optimized image data are determined in relation to at least one image standard for each image class in order to determine image class specific individualization-identification data.

12. Process according to claim 8, wherein customer specific or customer group specific manipulation parameters are recorded and stored for use with later reproduction orders, or for modification upon later customer complaints and subsequently used.
